(19) United States
(12) Patent Application Publication
(10) Pub. No.: US 2009/0306850 A1
(43) Pub. Date: Dec. 10, 2009

(54) System for monitoring DPF using wireless communication

(76) Inventors: Chang-Q Lee, Daejeon (KR); Seong-Ho Lee, Daejeon (KR); Hong-Seok Jung, Daejeon (KR); Yong-Woo Kim, Daejeon (KR); Sang-Min Lee, Daejeon (KR); Sung-Hwan Kim, Daejeon (KR)

Correspondence Address: CLARK & BRODY, 1090 VERMONT AVENUE, NW, SUITE 250, WASHINGTON, DC, 20005, US

(21) Appl. No.: 12/310,972

(22) PCT Filed: Aug. 23, 2007
(86) PCT No.: PCT/KR2007/004049

§ 371 Date: Mar. 13, 2009

(30) Foreign Application Priority Data
Sep. 15, 2006 (KR) 10-2006-0089440

(51) Int. Cl. G08C 17/00

(52) U.S. Cl. 701/33; 701/35

(57) ABSTRACT

The present invention relates to a system for monitoring DPF which can inform a point of time for regenerating the DPF to a driver. The system for monitoring DPF using wireless communication, which comprises a filter for gathering PM (Particulate Matter) and at least one or more pressure sensors and temperature sensors, comprises a monitoring part and a server system.

### TECHNICAL FIELD

The present invention relates to a system for monitoring DPF (Diesel Particulate Filter), and more particularly, to a system for monitoring DPF which can inform a point of time for regenerating the DPF to a driver, thereby efficiently maintaining the DPF.

### BACKGROUND ART

Since a diesel engine has high durability comparing with a gasoline engine and also has an efficiency which is about 20 ˜30% higher than the gasoline engine, the diesel engine has an excellent performance in aspects of fuel efficiency and output power and thus it is typically used in heavy transport vehicles such as a truck, a bus and the like. Further, since the diesel engine exhausts only a small amount of CO₂, CO, THC and evaporative hydrocarbon, it has less effect on global warming. Thus, the diesel engine is gradually employed in middle and small sized vehicles and the demand for the middle and small sized diesel vehicles is continuously increased in many advanced nations. However, NOx and PM (Particulate Matter) contained in exhaust gas of the diesel vehicles account for 40% of the entire air pollutants and thus are known as main factors of air pollution. Therefore, various environmental regulations are strictly applied to manufacturing of the diesel vehicles. Emission standard of the NOx and PM is determined by a compromise among relevant nations, and each nation controls the emission standard according to their political requirements. However, according as oil prices are increased massively, the diesel vehicles have the limelight due to the fuel efficiency which is higher than the gasoline vehicles. In order to reduce the emission of air pollutants, each nation tightens the emission regulations of the diesel engine.

Techniques for satisfying the emission regulations of the diesel engine is classified into a pre-treatment technique which fundamentally reduces the pollutants by improving fuel, a combustion method, an engine and so on, and an post-treatment technique which is disposed at an exhaust port so as to purify the exhaust gas. Research and development in the above technical fields has been steadily processed, however, it is evaluated that the post-treatment technique is more advantageous to commercialization. Accordingly, more research and development efforts for the post-treatment technique are being processed. The post-treatment includes (1) an oxide catalyst system for purifying unburned hydrocarbon contained in the PM, (2) a Diesel Particulate Filter (DPF) for filtering the PM and (3) a DeNOx catalyst system for resolving or deoxidizing the NOx in an oxygen atmosphere.

Particularly, the DPF system is known as an optimal system which has a wall-flow structure having fine pores of a few micrometers (μm) in size so that 90% or more of the PM can be filtered. In general, a filter, which is widely used in the DPF system, is formed into a cylindrical shape made of a porous material and having a circular or elliptical section. Also a small triangular or quadrangular section is formed in the filter, and channels, of which an inlet and an outlet are alternately stopped up, are arranged in the form of a honeycomb.

Hereinafter, an operation principle of the filter will be described. When the exhaust gas containing the PM is introduced through the inlet, gas can be escaped to the outside through a porous wall while being moved to other channels because the outlet is stopped up, but the PM is caught and gathered in the porous wall. A filtering process of the PM is called “a trapping process”. Then, in order for the DPF system to continuously filter the PM, the PM should be resolved into CO₂ by using a catalyst or thermal decomposition method and then discharged to the outside. However, if a speed of resolving the PM is slower than a speed of gathering the PM, the filter system may be clogged up by the PM. As the result, the exhaust gas can not be discharged and the engine is stopped by a back pressure. When the filter is out of order due to the fast gathering of the PM, the filter can be recycled by “a regeneration process” in which the PM gathered in the filter is resolved by the catalyst, burning or thermal composition method. As described above, the DPF technique can be divided into a trapping technique and a regeneration technique.

According to various solutions for the regeneration technique, the DPF system can be also classified into a passive-type DPF and an active-type DPF. Recently, since there is a tendency that a temperature of the exhaust gas becomes lower due to development of the diesel engine and the demand for the middle and small sized diesel vehicles is continuously increased (the temperature of the exhaust gas in the middle and small sized diesel vehicles is lower than that in the large sized diesel vehicle), the active-type DPF is preferred. In the active-type DPF, the exhaust gas is forcingly heated to 550° C. or more by using a heat source and then the heated exhaust gas is introduced into the filter, thereby simultaneously performing the trapping and regeneration processes. There are two heating methods which are widely used in the field. In a first method, an electric heater is disposed between the outlet through which the exhaust gas is discharged and the DPF so as to heat the exhaust gas. And in a second method, diesel fuel is injected to a position where the electric heater is disposed and then burned so as to be used as the heat source.

If the PM is continuously gathered in the DPF system, a passage through which the exhaust gas is discharged is clogged up, and thus environmental difference is increased at front and rear sides of the DPF system. A temperature sensor and a pressure sensor are provided at the front and rear sides of the DPF system, and an amount of the PM gathered in the DPF system is measured by using a temperature and pressure difference between the front and rear sides of the DPF. In addition, there is also provided a warning unit for informing a driver when the measured amount of the PM reaches saturation point of the DPF system. Typically, the warning unit is connected with ECU (Electric Control Unit) or provided with a separate processing unit so as to inform the driver when the measured amount of the PM reaches saturation point.

In a conventional warning unit, the pressure difference between the front and rear sides of the DPF system was used to determined whether the DPF was saturated with the PM. In a simple example, firstly, a pressure difference value between the front and rear sides of the DPF system when the DPF is saturated with the PM are experimentally obtained. Then, when an actual pressure difference value reaches the obtained value or an approximate value (e.g., about 70%) of the obtained value, a warning is sent out. Of course, unlike environmental conditions in a laboratory, actual operation conditions of the DPF system are affected by many variables. There have been proposed various solutions in order to solve the problem. Basically, on the basis of an appropriate decision using values of various physical quantities (e.g., temperature, pressure and the like) which are measured at a certain time or values which are measured for a predetermined time period, the solutions send out a warning to the driver when the DPF is saturated. However, there are some differences among them depending on physical quantities, algorithms and decision standards to be used. Typically, such a DPF system measures the physical quantities (e.g., temperature, pressure and the like) every second or minute during its operation. The measured data is recorded and stored in a memory. Since only some of the measured values are needed to determine a status of the DPF, the memory stores only some measured values in turn. Therefore, it is not necessary for the memory to store the measured values cumulatively.

Meanwhile, the PM gathered in the DPF is not completely burned out. Thus, since the remained PM is accumulated in the DPF, the back pressure between the front and rear sides of the DPF system is gradually increased according as the DPF is superannuated. In the case of the conventional DPF warning unit, the driver can have only the information indicating whether or not the DPF is saturated, but he/she can not have the information about a superannuated status of the DPF and a time for replacing the DPF. Furthermore, in the case of a vehicle in which the superannuated DPF is installed, the PM contained in the exhaust gas can not be removed effectively and also the exhaust gas is not discharged smoothly, whereby a bad effect is exerted to the engine. In addition, when the driver becomes aware of the superannuated status of the DPF, he/she visits a service center. The service center side inspects the DPF and then informs an exact status of the DPF to the driver. Therefore, if the driver is not aware of the superannuated status of the DPF and thus he/she does not visit the service center, the driver can not know the exact status of the DPF. In other words, if the driver does not have general knowledge of the vehicle, he/she can not request an inspection of the superannuated DPF at the right moment. In this case, an efficiency of reducing the exhaust gas is lowered and thus the environmental pollution problem is raised. Also, since the bad effect is exerted to the engine, the driver incurs an economical injury.

### DISCLOSURE

### Technical Problem

An object of the present invention is to provide a system for monitoring DPF using wireless communication, in which can inform a point of time for regenerating the DPF to a driver and also can cumulatively store the data in a remote area using the wireless communication so that the driver can know an exact status of the DPF in real time.

### Technical Solution

In order to solve the above problem, the present invention provides a system for monitoring DPF using wireless communication, which comprises a filter for gathering PM (Particulate Matter) and at least one or more pressure sensors and temperature sensors for measuring a pressure and a temperature of exhaust gas at front and rear sides of the filter, comprising a monitoring part comprising a transmitting unit for transmitting a signal through a network, and a control unit which is connected with the transmitting unit so as to receive values measured by the pressure sensors and temperature sensors and to convert the measured values into an wireless communication signal which can be recognized individually and then to transmit the converted signal to the transmitting unit; and a server system comprising a receiving unit which is connected with at least one or more monitoring part so as to receive the signal from the monitoring part through the network, a storing unit for storing information, an input/output unit for inputting/outputting the information, and a CPU (central processing unit) which is connected with the receiving unit, the storing unit and the input/output unit so as to process the signal from the receiving unit and store the measured values by vehicles and also to process and output the stored information according to a user's request.

Preferably, the monitoring part further comprises a warning unit for informing a saturation status of the DPF to a driver, and the control unit operates the warning unit according to a predetermined algorithm using the measured values when the DPF is saturated.

Preferably, the monitoring unit further comprises a sub-memory which is connected with the control unit so as to temporarily store the measured values by the control unit when communication is interrupted.

Preferably, the control unit is formed independently of an ECU (Electric Control Unit) or integrally with the ECU, or the control unit is provided in the ECU.

Preferably, the server system further comprises an SMS transmitting unit which is connected with the CPU so as to automatically transmit a message of a status of a vehicle to a driver of the vehicle which is stored in the server system, according to a result of reading the information from a certain monitoring unit.

### ADVANTAGEOUS EFFECTS

According to the present invention, since a driver can know an exact status of the DPF in real time, it is possible to solve the problem in the conventional DPF that the driver can have only the information indicating whether or not the DPF is saturated, but he/she can not have the information about a superannuated status of the DPF and a time for replacing the DPF. Therefore, it allows the driver to facilely know the status of the DPF and the replacing time at any time and also to cope with the situation immediately. Further, it eliminates a possibility that a bad effect is exerted to vehicle parts related to the DPF system, particularly, the engine.

In addition, according to the system for monitoring DPF using wireless communication of the present invention, the driver can facilely know an exact status of the vehicle in the home. If the system of the present is employed in a service center, a transport company and so on, it is possible to exactly grasp a status of a certain vehicle group in real time and to cope with troubles of the vehicle immediately. Further, since the status of the certain vehicle group is monitored in real time, it will do much to alleviate the air pollution. Also the stored information can be used as basic data for research and development of a new product.

### DESCRIPTION OF DRAWINGS

The above and other objects, features and advantages of the present invention will become apparent from the following description of preferred embodiments given in conjunction with the accompanying drawings, in which:

FIG. 1 is a schematic view of a vehicle system including a conventional DPF and engine.

FIG. 2 is a schematic view of a system for monitoring DPF using wireless communication according to the present invention.

FIG. 3 is a view showing a paradigm of the system for monitoring DPF using wireless communication according to the present invention.

### DETAILED DESCRIPTION OF MAIN ELEMENTS

100: DPF system
101: filter
102: heating unit
103a: inlet pressure sensor
103b: outlet pressure sensor
104a: inlet temperature sensor
104b: outlet temperature sensor
200: engine
201: charging unit
202: rpm sensor
203: battery
204: ventilation pump
205: ventilation valve
206: exhaust gas port
300: ECU
400: warning unit
1000: system for monitoring DPF using wireless communication
1100: monitoring part
1101: control unit
1102: transmitting unit
1103: sub-memory
1200: server system
1201: receiving unit
1202: storing unit
1203: input/output unit
1204: CPU
1205: SMS transmitting unit

### BEST MODE

Hereinafter, the embodiments of the present invention will be described in detail with reference to accompanying drawings.

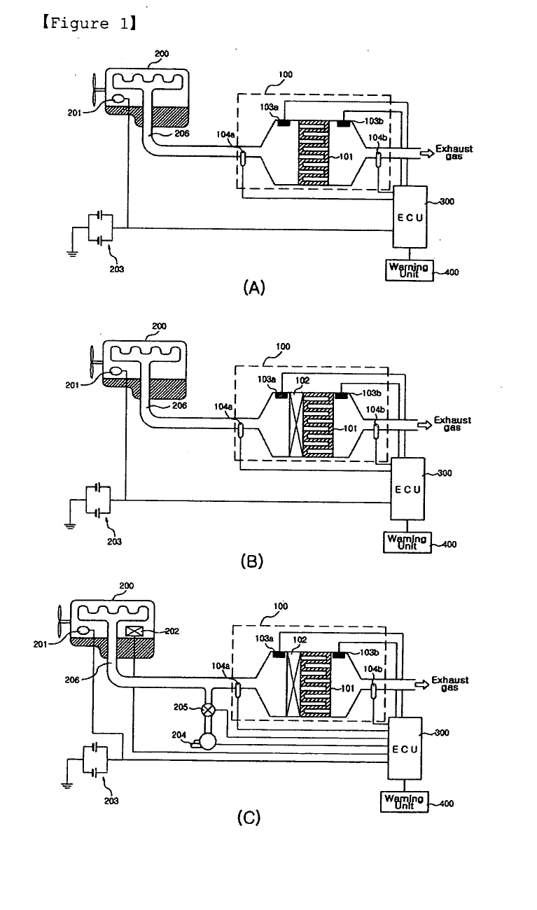

FIG. 1 is a schematic view of a vehicle system including a conventional DPF and engine. A DPF system will be described with reference to the drawing. FIG. 1A shows a passive-type DPF system and FIG. 1B shows an active-type DPF system. The passive-type DPF system lowers an ignition temperature of PM using a catalyst or an additive so that the PM can be removed by using only a temperature of exhaust gas itself. The passive-type DPF is widely used in heavy-duty vehicles. The active-type DPF system applies heat to the gathered PM from the outside so that the PM can be burned out. The active-type DPF system had been studied at an early stage, but the passive-type DPF system had been widely used due to difficulty in commercialization of the active-type DPF system. However, since only the passive-type DPF system can not sufficient for a small-sized vehicle, recently, research and development of the active-type DPF system is processed again.

In the passive-type DPF system shown in FIG. 1A, the ignition temperature of the PM is lowered by coating the catalyst on a filter 101, mixing the additive to fuel, or spraying the additive at a front side of a DPF system 100, so that the PM can be removed. When the fuel is burned and thus an operation is occurred in the engine, the exhaust gas is discharged and then introduced into the DPF system 100. Since the DPF system is provided with the filter 101 coated with the catalyst, the PM contained in the exhaust gas is removed while the exhaust gas is passed through the filter 101. Otherwise, an additive spraying device (not shown) is provided at a position where the exhaust gas containing the PM is introduced, so as to lower an ignition temperature of the PM, thereby burning out the PM. The remaining PM is gather in the filter 101 and then removed. The DPF system 100 is provided with a pressure sensor 103a, 103b and a temperature sensor 104a, 104b so as to measure a pressure and a temperature at front (inlet) and rear (outlet) sides of the DPF system 100. Of course, the pressure sensor 103a, 103b and temperature sensor 104a, 104b may be provided only at either of the front and rear sides of the DPF system 100 or at both sides thereof. The pressure and temperature measured by the pressure sensor 103a, 103b and temperature sensor 104a, 104b become an indicator for determining whether the PM is smoothly removed or whether the filter 101 is saturated with the PM. If the pressure and temperature reaches a predetermined standard, an ECU 300 determines that the DPF system 100 is not operated normally and then operates a warning unit 400 so as to inform the status to the driver.

FIG. 1B shows an example of the active-type DPF system. As described above, in the active-type DPF system, the heat is applied from the outside so as to raise the temperature of the exhaust gas so that the PM can be removed. Therefore, unlike the passive-type DPF system, the active-type DPF system has a heating unit 102. The passive-type and active-type DPF systems are operated by the same operation principle, except that the passive-type DPF system lowers the ignition temperature of the PM using the catalyst or additive, but the active-type DPF system raises the temperature of the exhaust gas by exerting the heat from the outside so that the temperature of the exhaust gas can reach the ignition temperature.

FIG. 1C is a schematic view showing a DPF system in which the passive-type and active-type are mixed. In this DPF system, the filter 101 (in the case of the passive-type) or the heating unit 102 (in the case of active-type) is provided at a passage connected with an exhaust gas port 206, and the pressure sensor 103a, 103b and temperature sensor 104a, 104b connected with the ECU 300 are provided at either of the front and rear sides of the DPF system or at both sides thereof. Generally, as shown in FIG. 1C, the DPF system is further provided with additional units. The operation principle of the DPF system will be described in detail referring to FIG. 1C.

First of all, when the combustion of fuels and the associated operations are occurred in the engine, a battery 203 is charged by a charging unit 201. An rpm of the engine 200 generated during the charging operation is detected by an rpm sensor 202 and the exhaust gas is discharged through the exhaust gas port 206. Values measured by the rpm sensor 202 and other sensors to be disclosed blow are sent to the ECU 300. The ECU 300 controls operation parts using the measured values. As described above, the controlling of the ECU 300 may be performed by using only the pressure sensor 103a, 103b and temperature sensor 104a, 104b. However, the rpm sensor 202 is typically used to exactly determine the relationship between an amount of the exhaust gas and the temperature and pressure values. Although not shown in the drawings, two or more DPF systems 100 are generally provided so that the exhaust gas is selectively introduced into one of the DPF systems 100 by using a selection value (not shown). However, for the sake of convenience, only one DPF system is provided in the description. An amount of air to be supplied by a ventilation pump 204 is determined by a ventilation value 205 controlled by the ECU 300. The supplied air is mixed with the exhaust gas and then introduced into the DPF system 100. The exhaust gas of which the temperature is increased by the heating unit 102 is introduced into the filter 101. The heating unit 102 includes an electric heater connected with the battery 203 and a diesel injector for injecting the diesel fuel to burn out the exhaust gas. The filter 101 is formed into a cylindrical shape made of a porous material and its section has a circular or elliptical shape or other shape including metal mesh, metal foam, metal fiber, ceramic foam and the like. Also a small triangular or quadrangular section is formed within the filter, and channels, of which an inlet and an outlet are alternately stopped up, are arranged in the form of a honeycomb. When the exhaust gas containing the PM is introduced through the inlet, gas can be escaped to the outside through a porous wall while being moved to other channels because the outlet is stopped up, but the PM is caught and gathered in a porous wall. Further, the filter is coated with the catalyst or provided with a separate device so as to remove NOx as well as the PM. The inlet pressure sensor 103a, inlet temperature sensor 104a, outlet pressure sensor 103b and outlet temperature sensor 104b are provided at the front (inlet) and rear (outlet) sides of the DPF system 100. As shown in the drawing, all of the sensors are connected with the ECU 300. The ECU 300 controls the heating unit 102 so as to generate a predetermined amount of heat according to a result calculated by a predetermined algorithm using the values measured from the rpm sensor 202, temperature sensor 104a, 104b and pressure sensor 103a, 103b. Since the ECU 300 is provided with the warning unit 400, if it is determined that an amount of the PM gathered in the filter 101 of the DPF system exceeds a standard value on the basis of the result calculated by using the values measured from the various sensors, the ECU 300 controls the warning unit 400 to inform the fact to the driver.

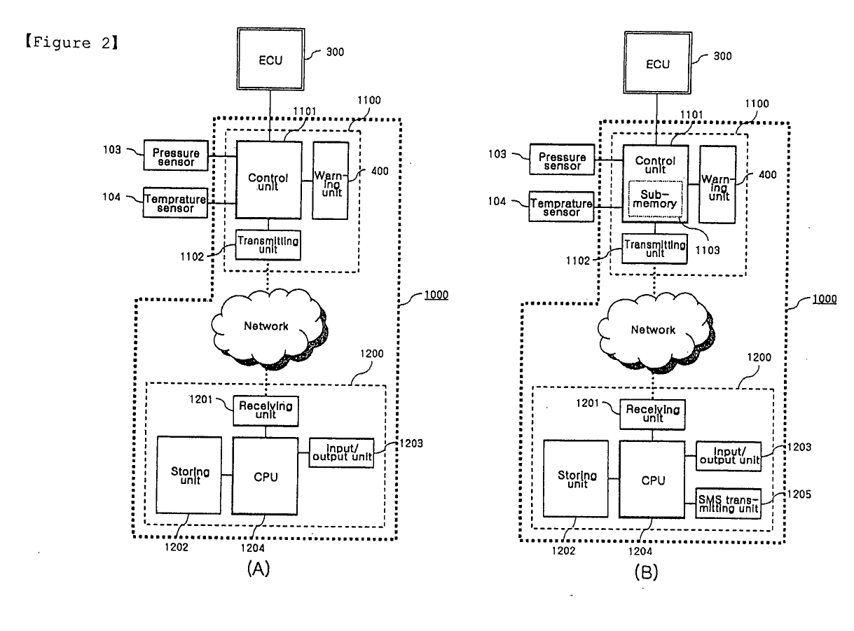

FIG. 2 is a schematic view of a system for monitoring DPF using wireless communication according to the present invention. The conventional warning unit 400 shown in FIG. 1 is simply turned on/off by the ECU 300, and it includes a warning lamp, a sound output unit and the like, which is provided near a driver's seat. As shown in FIG. 2A, a system for monitoring DPF using wireless communication by the present invention is comprised of a monitoring part 1100 which is installed at the vehicle and a server system 1200. The server system 1200 includes a receiving unit 1201 for receiving a signal through a network like wire or wireless Internet, a storing unit 1202 for storing information, an input/output unit 1203 for inputting/outputting the information, and a CPU (Central Processing Unit) 1204 which processes the signal from the receiving unit 1201 and stores the processed signal in the storing unit 1202, and also processes the information and then outputs a result according to a command input from the input/output unit 1203. The monitoring part 1100 provided at the DPF system 100 of each vehicle includes a warning unit 400 for informing a saturation status of the DPF to the driver, a transmitting unit 1102 for transmitting a signal through the network like wire or wireless Internet, and a control unit 1101 which receives and processes the measured value from the pressure sensor 103a, 103b and the temperature sensor 104a, 104b and then transmits a signal to the transmitting signal, and calculates an amount of the PM gathered in the filter 101 by a predetermined formula using the measured values, and operates the warning unit 400 according to a predetermined algorithm. In the embodiment of FIG. 2, the pressure sensor 103a, 103b and temperature sensor 104a, 104b are directly connected with the monitoring part 1100. However, it is not necessary that the pressure sensor 103a, 103b and temperature sensor 104a, 104b should be directly connected with the monitoring part 1100. Instead, the ECU 300 may be connected with the monitoring part 1100 so that the measured values is transmitted to the ECU 300 (as shown in FIG. 1), and the ECU 300 transmits the measured values to the control unit 1101 of the monitoring part 1100. Further, the control unit 1101 may be softwarely provided in the ECU 300 so that the control unit 1101 is integrally formed with the ECU 300.

The control unit 1101 of the monitoring part 1100 receives the pressure and temperature values measured at the front and rear sides of the DPF system 100 by the pressure sensor 103a, 103b and the temperature sensor 104a, 104b in the DPF system 100. And like in the conventional warning unit, the control unit 1101 calculates an amount of the PM gathered in the filter 101 by a predetermined formula using the measured values, and operates the warning unit 400 according to a predetermined algorithm. The algorithm informs the saturation status to the driver when the calculated amount of the gathered PM exceeds a predetermined standard or when the value measured by the pressure sensor 103a, 103b exceeds a predetermined standard.

In addition, the control unit 1101 transmits all of the signals to the transmitting unit 1102, and the transmitting unit 1102 transmits the signals through a network. At this time, the signals are treated so as to be recognized individually. Therefore, when the signals are transmitted from at least one or more monitoring part 1100, it is possible to distinguish the signals from each monitoring part 1100.

The signal transmitted from the monitoring part 1100 is transmitted through the network to a server system 1200. The CPU 1204 of the server system 1200 classifies the signals received from the transmitting unit 1102 according to each monitoring part 1100 and then stores them in the storing unit 1202. In other words, the pressure and temperature values of the DPF system 100, which are transmitted from the monitoring part 1100 of each vehicle, are cumulatively stored in the storing unit 1202. The CPU 1204 also function to process the information properly so as to output the information to the input/output unit 1203 using the stored pressure and temperature values when a user requests. For example, when the user requests statistics about a vehicle A for last week, the CPU 1204 takes the statistics of the pressure/temperature values of the vehicle A for last week by dates and times and then prepares and outputs a graph thereof. Of course, it may be possible to output a transition of the amount of the PM gathered in the DPF of the vehicle A for last week from the stored values using the same formula and algorithm as those used in the control unit 1101 of the monitoring part 1100. As described above, a method of processing the information in the CPU 1204 depends on the user's object and necessity.

FIG. 2B shows another embodiment of the monitoring part using wireless communication according to the present invention. In the embodiment, the control unit 1101 further includes a sub-memory 1103. Unlike a building or fixture of which a position is fixed, a position of vehicle is changed whenever necessary. Therefore, when the vehicle is positioned at a place where the wireless communication is interrupted, the signal from the monitoring part 1100 may not be transmitted to the server system 1200 and then may be omitted. The sub-memory as shown in FIG. 2B is provided to avoid this problem. That is, in the case that the vehicle is positioned at a place where the wireless communication is interrupted, the control unit 1101 decides that the wireless communication is interrupted at the present position and then does not transmit the measured values from the pressure sensor 103a, 103b and temperature sensor 104a, 104b to the transmitting unit 1102 but transmits them to the sub-memory 1103 so as to be stored therein. If the vehicle is moved to a place where the wireless communication is restored, the control unit 1101 decides that the communication is restored and then transmits the stored values in the sub-memory 1103 together with the values measured at the present time. Since the measured values include a measurement time as well as the pressure/temperature values, the server system 1200 can exactly store the omitted values.

As an example, the measured values to be transmitted are stored in the sub-memory 1103 for a predetermined period of time, e.g., one to six months. The pressure/temperature values are stored once per one or two seconds, but to transmit the data whenever the values are stored is very inefficient. Therefore, the measured values for a predetermined period of time, e.g., one day are stored in one file and then the data is transmitted at a proper time (e.g., 9, 12, 3 or 6 o'clock every day). Further, when transmitting the data, only the data stored on the day before may be transmitted. However, the data stored for three days may be transmitted at a time, thereby preventing the omission of the data.

As shown in FIG. 2B, the CPU 1204 of the server system 1200 is further provided with the input/output unit 1203. Since the CPU 1204 functions to store the data and also to process the data in real-time, although some troubles are occurred at a vehicle in which a certain monitoring part 1100 is installed, or a status of the DPF is deteriorated, it is possible to find it in real-time. In the case that a contact address of the driver of the vehicle in which the monitoring part 1100 is installed is previously stored in the server system 1200, the input/output unit 1203 automatically transmits to the driver a message informing that an inspection of the vehicle is needed or troubles are occurred in the vehicle.

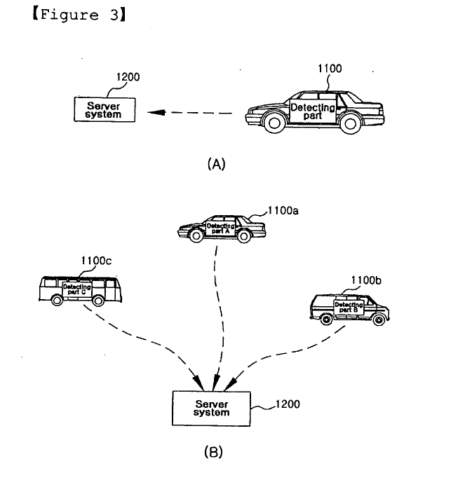

FIG. 3 is a view showing a paradigm of the system for monitoring DPF using wireless communication according to the present invention. As described above, the server system 1200 can be connected with at least one or more monitoring parts 1100. As shown in FIG. 3A, for example, the driver may install the server system 1200 at his/her home. In this case, the driver or his/her family can exactly grasp the status of vehicle through the monitoring part 1100 in real-time.

Furthermore, the driver may register his/her own monitoring part 1100 in the server system 1200 of a service center. As shown in FIG. 3B, the server system 1200 in the service center receives signals from a plurality of monitoring parts 1100 and then stores and processes the data by vehicles. As described above, in the case that the server system 1200 is further provided with the input/output unit 1203, if the troubles are occurred in the vehicle of a certain user or an abnormal status is found, such the information is automatically transmitted to the user so as to cope with troubles of the vehicle immediately.

The system for monitoring DPF using wireless communication according to the present invention can be individually bought and used, but it is the most efficient that the system is used in a group or a company which manages multiple vehicles. In the case of a service center, a taxi or bus company, a transport company and the like, which manages multiple vehicles, a status of each vehicle can be grasped in real-time by using the system for monitoring DPF using wireless communication according to the present invention. Particularly, an offerer who provides the server system 1200 may exists independently so as to manage a plurality of individuals and a group (including the service center, the taxi or bus company, the transport company and the like) with the single server system 1200. Since each individual or group just installs the monitoring parts 1100 in its own vehicles and then registers the monitoring parts 1100 in the server system 1200 of the offerer, it is convenient for the users to use the system for monitoring DPF using wireless communication according to the present invention. In this case, the server system 1200 may be divided into a central server and a local server. For example, in the case of the bus company, each bus approaches invariably and periodically the service center of the company. Therefore, a unit server is provided at the service center so as to communicate with each bus and thus collect the data. The unit server collates the collected data and then transmits to the central server. In this method, since each bus invariably approaches the unit server in a desired distance, it is not necessary for the monitoring part installed in the bus to have a high performance enough for telecommunication. But it is sufficient that the monitoring part has a performance enough for RF communication. Therefore, an entire cost of equipment can be reduced, and also operation expenses are lowered by using the RF communication.

In addition, the server system 1200 can contribute to the environmental problem. For example, in the case that all of the vehicles of a transport company are provided with the monitoring part 1100 and thus the status of DPF of each vehicle is monitored through the server system 1200 of the company in real-time, the transport company can quickly grasp troubles of each vehicle and then immediately copes with the troubles, thereby reducing damages of the vehicles as well as the exhaust gas which pollutes air.

Furthermore, the cumulatively stored data becomes very useful information of showing an operation status of the vehicle which is monitored by the monitoring part 1100. In other words, since the data can be used as basic information for understanding a performance of the vehicle, the data becomes very useful for car makers to develop a new vehicle.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

According to the system for monitoring DPF using wireless communication of the present invention, the driver can facilely know an exact status of the vehicle in the home. If the system of the present is employed in a service center, a transport company and so on, it is possible to exactly grasp a status of a certain vehicle group in real time and to cope with troubles of the vehicle immediately.

1. A system for monitoring DPF using wireless communication, which comprises a filter for gathering PM (Particulate Matter) and at least one or more pressure sensors and temperature sensors for measuring a pressure and a temperature of exhaust gas at front and rear sides of the filter, comprising:
a monitoring part comprising a transmitting unit for transmitting a signal through a network, and a control unit which is connected with the transmitting unit so as to receive values measured by the pressure sensors and temperature sensors and to convert the measured values into an wireless communication signal which can be recognized individually and then to transmit the converted signal to the transmitting unit; and
a server system comprising a receiving unit which is connected with at least one or more monitoring part so as to receive the signal from the monitoring part through the network, a storing unit for storing information, an input/output unit for inputting/outputting the information, and a CPU (central processing unit) which is connected with the receiving unit, the storing unit and the input/output unit so as to process the signal from the receiving unit and store the measured values by vehicles and also to process and output the stored information according to a user's request.

2. The system for monitoring DPF using wireless communication according to claim 1, wherein the monitoring part further comprises a warning unit for informing a saturation status of the DPF to a driver, and the control unit operates the warning unit according to a predetermined algorithm using the measured values when the DPF is saturated.

3. The system for monitoring DPF using wireless communication according to claim 2, wherein the monitoring unit further comprises a sub-memory which is connected with the control unit so as to temporarily store the measured values by the control unit when communication is interrupted.

4. The system for monitoring DPF using wireless communication according to claim 1, wherein the control unit is formed independently of an ECU (Electric Control Unit) or integrally with the ECU, or the control unit is provided in the ECU.

5. The system for monitoring DPF using wireless communication according to claim 4, wherein the server system further comprises an SMS transmitting unit which is connected with the CPU so as to automatically transmit a message of a status of a vehicle to a driver of the vehicle which is stored in the server system, according to the result of reading the information from a certain monitoring unit.

6. The system for monitoring DPF using wireless communication according to claim 2, wherein the control unit is formed independently of an ECU (Electric Control Unit) or integrally with the ECU, or the control unit is provided in the ECU.

7. The system for monitoring DPF using wireless communication according to claim 3, wherein the control unit is formed independently of an ECU (Electric Control Unit) or integrally with the ECU, or the control unit is provided in the ECU.
